(19) United States
(12) Patent Application Publication
(10) Pub. No.: US 2008/0101327 A1
(43) Pub. Date: May 1, 2008

(54) Apparatus and method for space-time coding adaptive to number of antennas in multiple input multiple output wireless communication system

(75) Inventors: Yung-Soo Kim, Seoul (KR); Cheol-Woo You, Seoul (KR); Young-Ho Jung, Suwon-si (KR); In-Soo Hwang, Yongin-si (KR); Eun-Mo Kang, Yongin-si (KR)

Correspondence Address: DOCKET CLERK, P.O. DRAWER 800889, DALLAS, TX, 75380, US

(73) Assignee: Samsung Electronics Co., Ltd., Suwon-si (KR)

(21) Appl. No.: 11/982,070

(22) Filed: Nov. 1, 2007

(30) Foreign Application Priority Data
Nov. 1, 2006 (KR) 2006-0107370

(51) Int. Cl. H04J 3/00

(52) U.S. Cl. 370/345

(57) ABSTRACT

Provided is a transmitter apparatus in a MIMO wireless communication system. The transmitter apparatus includes a controller and a space-time encoder. The controller generates a space-time encoding code according to a multiplexing order, the number of transmitter antennas, and the number of receiver antennas. The space-time encoder space-time-encodes a TX signal using the generated space-time-encoding code.

### CROSS-REFERENCE TO RELATED APPLICATION(S) AND CLAIM OF PRIORITY

This application claims priority under 35 U.S.C. §119 to an application filed in the Korean Intellectual Property Office on Nov. 1, 2006 and allocated Serial No. 2006-107370, the contents of which are incorporated herein by reference.

### TECHNICAL FIELD OF THE INVENTION

The present invention relates generally to a multiple input-multiple output (MIMO) wireless communication system, and in particular, to an apparatus and method for space-time coding adaptive the number of antennas in a MIMO wireless communication system.

### BACKGROUND OF THE INVENTION

A variety of multimedia services in wireless environments is demanded by the rapid growth of mobile communication markets. Large-capacity data must be transmitted at a high speed in order to provide the multimedia services. Thus, research is being conducted on a multiple input-multiple output (MIMO) system for efficiently using limited frequency resources.

Compared to a single-antenna system, the MIMO system can increase transmission reliability and a data rate without allocating additional frequencies or transmit (TX) power. That is, the MIMO system uses a diversity scheme for increasing transmission reliability by achieving a diversity gain according to the number of transmitter (TX) and receiver (RX) antennas, a multiplexing scheme for increasing a data rate by simultaneously transmitting a plurality of signal sequences, and a hybrid scheme of the diversity scheme and the multiplexing scheme.

In order to achieve a lower error rate, a MIMO wireless communication system uses a space-time coding scheme that extends coding of the time domain to the space domain. Examples of space-time codes for the MIMO wireless communication system are an Alamouti space-time code for a diversity effect, a BLAST space-time code for a multiplexing effect, and a hybrid space-time code for a trade-off between the diversity effect and the multiplexing effect.

In order to provide a space-time coding scheme suitable for a channel environment and the number of usable antennas of a receiver, a transmitter of the MIMO wireless communication system stores all the space-time codes for a variety of channel environments. Based on feedback information received from the receiver, the transmitter selects a suitable space-time code to perform space-time coding.

This, however, complicates the feedback information from the receiver and leads to a waste of memory in the transmitter.

### SUMMARY OF THE INVENTION

To address the above-discussed deficiencies of the prior art, it is a primary object of the present invention is to substantially solve at least the above problems and/or disadvantages and to provide at least the advantages below. Accordingly, an object of the present invention is to provide an apparatus and method for flexibly adjusting diversity or multiplexing orders in a multiple input-multiple output (MIMO) wireless communication system.

Another object of the present invention is to provide an apparatus and method for generating a suitable space-time code by combination of basises in a MIMO wireless communication system.

Still another object of the present invention is to provide an apparatus and method for generating a space-time code in a MIMO wireless communication system by using some basises of prestored basises according to the number of usable antennas.

Even another object of the present invention is to provide an apparatus and method for generating a space-time code in a MIMO wireless communication system by using extension basises of prestored basises according to the number of usable antennas.

According to one aspect of the present invention, a transmitter apparatus in a MIMO wireless communication system includes: a controller for generating a space-time encoding code according to a multiplexing order, the number of transmitter antennas, and the number of receiver antennas; and a space-time encoder for space-time-encoding a transmit (TX) signal using the generated space-time-encoding code.

According to another aspect of the present invention, a receiver apparatus in a MIMO wireless communication system includes: a determiner for determining a multiplexing order using a channel estimation value; a controller for generating a space-time decoding code according to the determined multiplexing order; and a space-time decoder for space-time-decoding a receive (RX) signal received from a transmitter using the generated space-time-decoding code.

According to still another aspect of the present invention, a method for an operation of a transmitter in a MIMO wireless communication system includes the steps of: generating a space-time encoding code according to a multiplexing order, the number of transmitter antennas, and the number of receiver antennas; and space-time-encoding a transmit (TX) signal using the generated space-time-encoding code.

According to even another aspect of the present invention, a method for an operation of a receiver in a MIMO wireless communication system includes the steps of: determining a multiplexing order using a channel estimation value; generating a space-time decoding code according to the determined multiplexing order; and space-time-decoding a receive (RX) signal received from a transmitter using the generated space-time-decoding code.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 is a block diagram of a transmitter for a MIMO wireless communication system according to an embodiment of the present invention;

FIG. 2 is a block diagram of a receiver for a MIMO wireless communication system according to an embodiment of the present invention;

FIG. 3 is a flowchart illustrating a space-time coding procedure in a transmitter for a MIMO wireless communication system according to an embodiment of the present invention; and

FIG. 4 is a flowchart illustrating a space-time decoding procedure in a receiver for a MIMO wireless communication system according to an embodiment of the present invention.

### DETAILED DESCRIPTION OF THE INVENTION

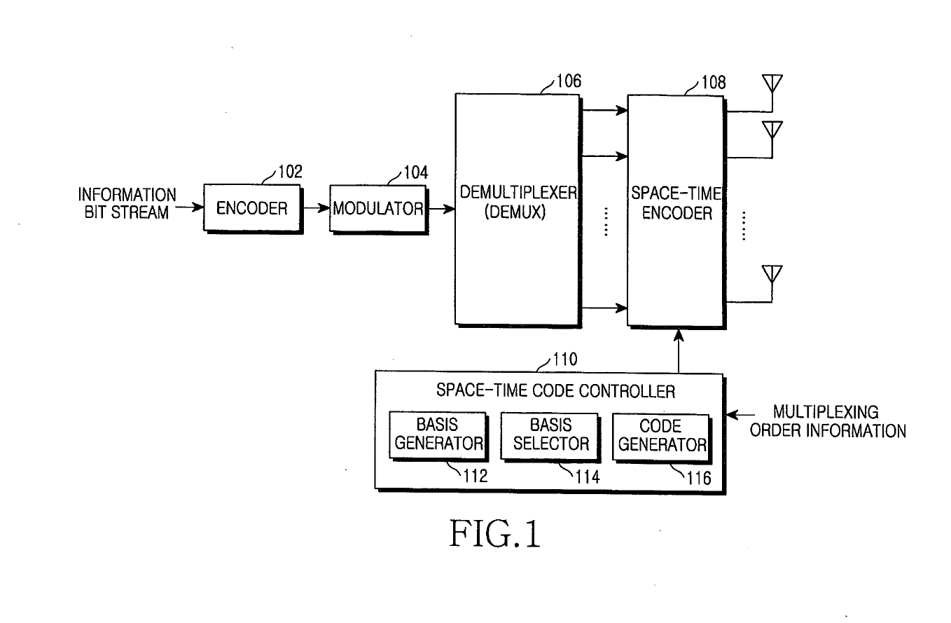

FIGS. 1 through 4, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged wireless network.

The present invention is intended to provide a technique for performing space-time coding in a multiple input-multiple output (MIMO) wireless communication system by flexibly adjusting a diversity order and a multiplexing order according to channel environments and the number of usable antennas. The diversity order is the number of times of repetition of the same signal on the time or frequency axis. The multiplexing order is the number of signals that can be simultaneously received by a receiver.

A basis is a basic component that can express all of one space. In a basis set, each basis is linearly independent of other basises and spans a basis space.

The following description is made on the assumption that a transmitter and a receiver of the MIMO wireless communication system each have two antennas (i.e., 2×2) and diversity and multiplexing orders are adjusted according to the combination of basises.

An Alamouti code, a typical diversity code, can be expressed as Equation 1:

$$\begin{matrix}{S}_{alamouti} = [ \begin{matrix}{s}_{1} & {s}_{2} \\ - {s}_{2}^{*} & {s}_{1}^{*}\end{matrix} ] \\ = [ \begin{matrix}{α}_{1} + j {β}_{1} & {α}_{2} + j {β}_{2} \\ - {α}_{2} + j {β}_{2} & {α}_{1} - j {β}_{1}\end{matrix} ] \\ = {α}_{1} [ \begin{matrix}1 & 0 \\ 0 & 1\end{matrix} ] + {α}_{2} [ \begin{matrix}0 & 1 \\ - 1 & 0\end{matrix} ] + \\ j {β}_{1} [ \begin{matrix}1 & 0 \\ 0 & - 1\end{matrix} ] + j {β}_{2} [ \begin{matrix}0 & 1 \\ 1 & 0\end{matrix} ]\end{matrix} \qquad [ Eqn . 1 ]$$

In Equation 1, Salamouti denotes an Alamouti code, sᵢ denotes the i^{th} transmit symbol, αᵢ denotes a real value of the i^{th} transmit symbol, βᵢ denotes an imaginary value of the i^{th} transmit symbol,

$$[ \begin{matrix}1 & 0 \\ 0 & 1\end{matrix} ]$$

and

$$[ \begin{matrix}0 & 1 \\ - 1 & 0\end{matrix} ]$$

denote real basises, and

$$[ \begin{matrix}1 & 0 \\ 0 & - 1\end{matrix} ]$$

and

$$[ \begin{matrix}0 & 1 \\ 1 & 0\end{matrix} ]$$

denote imaginary basises.

The Alamouti code is a diversity code that can provide the maximum diversity gain. However, as expressed in Equation 1, the transmitter transmits two complex symbols for two time periods using two (2) real basises and two (2) imaginary basises and thus has a data rate of 1 (=2 (the number of transmit (TX) symbols)/2 (transmit (TX) time periods)). That is, a 2×2 MIMO wireless communication system can provide a data rate of 2 by transmitting 4 symbols for 2 time periods, but the use of the Alamouti code results in a data rate of only 1 and cannot provide the maximum multiplexing gain for the transmitter and the receiver.

TX symbols of a BLAST code, a typical multiplexing code, can be expressed as Equation 2:

$$\begin{matrix}{S}_{blast} = [ \begin{matrix}{s}_{1} & {s}_{2} \\ {s}_{3} & {s}_{4}\end{matrix} ] \\ = [ \begin{matrix}{α}_{1} + j {β}_{1} & {α}_{2} + j {β}_{2} \\ {α}_{3} + j {β}_{3} & {α}_{4} + j {β}_{4}\end{matrix} ] \\ = {α}_{1} [ \begin{matrix}1 & 0 \\ 0 & 0\end{matrix} ] + {α}_{2} [ \begin{matrix}0 & 1 \\ 0 & 0\end{matrix} ] + {α}_{3} [ \begin{matrix}0 & 0 \\ 1 & 0\end{matrix} ] + {α}_{4} [ \begin{matrix}0 & 0 \\ 0 & 1\end{matrix} ] + \\ j {β}_{1} [ \begin{matrix}1 & 0 \\ 0 & 0\end{matrix} ] + j {β}_{2} [ \begin{matrix}0 & 1 \\ 0 & 0\end{matrix} ] + \\ j {β}_{3} [ \begin{matrix}0 & 0 \\ 1 & 0\end{matrix} ] + j {β}_{4} [ \begin{matrix}0 & 0 \\ 0 & 1\end{matrix} ]\end{matrix} \qquad [ Eqn . 2 ]$$

In Equation 2, S_{blast} denotes a BLAST code, sᵢ denotes the i^{th} transmit (TX) symbol, αᵢ denotes a real value of the i^{th} TX symbol, and βᵢ denotes an imaginary value of the i^{th} TX symbol.

Basises of the BLAST code can be expressed as Equation 3:

A_{M(τ-1)+m}=B_{M(τ-1)+m}=ξ_{τ}ηₘ^{t}, τ=(1, . . . , T), m=(1, . . . , M). [Eqn. 3]

In Equation 3, A denotes a real basis in the BLAST code, B denotes an imaginary basis in the BLAST code, T denotes the number of transmit (TX) antennas, M denotes the number of receive (RX) antennas, ξ denotes a T-dimensional column vector where only the τ^{th} element is 1 and the remaining elements are 0, and η denotes an M-dimensional column vector where only the m^{th} element is 1 and the remaining elements are 0.

The BLAST code is a multiplexing code that provides the maximum multiplexing gain. In the case of a 2×2 MIMO wireless communication system, both of T and M are 2 in Equation 2. Because there are 8 basises (A=4, B=4), the transmitter and the receiver can provide the maximum data rate, that is, the maximum multiplexing gain.

As expressed in Equations 1 and 2, the number of basises and coefficients multiplied by the respective basises vary depending on whether the code used is the diversity code or the multiplexing code. Therefore, the transmit (TX) symbol matrixes expressed in Equations 1 and 2 can be generalized as Equation 4:

$${S}_{2 \times 2} = {\sum }_{i = 1}^{I} {μ}_{i} {A}_{i} . \qquad [ Eqn . 4 ]$$

In Equation 4, A denotes the basises of a code, μ denotes coefficients of TX symbols (e.g., αᵢ and βᵢ in Equation 1), and I denotes the number of basises of the code (e.g., 4 for the Alamouti code and 8 for the BLAST code).

That is, the transmitter and the receiver can obtain a space-time code of desired diversity and multiplexing orders by designing a suitable basis set and adjusting the number of basises and coefficients multiplied by the basises. That is, the diversity or multiplexing orders are changed by adjusting the value of μ or I in Equation 4.

For example, using 4 basises of

$$γ [ \begin{matrix}1 & 0 \\ 0 & 1\end{matrix} ] , γ [ \begin{matrix}0 & 1 \\ - 1 & 0\end{matrix} ] , γ [ \begin{matrix}1 & 0 \\ 0 & - 1\end{matrix} ] ,$$

and

$$γ [ \begin{matrix}0 & 1 \\ 1 & 0\end{matrix} ] ,$$

and 4 basises of the Alamouti code expressed in Equation 1, a space-time code can be generated that can provide the maximum diversity gain and the maximum multiplexing gain in the 2×2 MIMO wireless communication system, as expressed in Equation 5. Herein, γ is a coefficient that is multiplied to indicate a different basis. If γ is j(\sqrt{−1}), the code becomes a perfect space-time code (PSTC).

$$\begin{matrix}{S}_{1} = {α}_{1} [ \begin{matrix}1 & 0 \\ 0 & 1\end{matrix} ] + {α}_{2} [ \begin{matrix}0 & 1 \\ - 1 & 0\end{matrix} ] + j {β}_{1} [ \begin{matrix}0 & 1 \\ 0 & - 1\end{matrix} ] + j {β}_{2} [ \begin{matrix}0 & 1 \\ 1 & 0\end{matrix} ] \\ = [ \begin{matrix}{s}_{1} & {s}_{2} \\ - {s}_{2}^{*} & {s}_{1}^{*}\end{matrix} ]\end{matrix} \\ \begin{matrix}{S}_{2} = γ ( {α}_{3} [ \begin{matrix}1 & 0 \\ 0 & - 1\end{matrix} ] + {α}_{4} [ \begin{matrix}0 & 1 \\ 1 & 0\end{matrix} ] + j {β}_{3} [ \begin{matrix}1 & 0 \\ 0 & 1\end{matrix} ] + j {β}_{4} [ \begin{matrix}0 & 1 \\ - 1 & 0\end{matrix} ] ) \\ = γ [ \begin{matrix}{s}_{3} & {s}_{4} \\ {s}_{4}^{*} & - {s}_{3}^{*}\end{matrix} ]\end{matrix} \\ S = [ \begin{matrix}{s}_{1} & {s}_{2} \\ - {s}_{2}^{*} & {s}_{1}^{*}\end{matrix} ] + γ [ \begin{matrix}{s}_{3} & {s}_{4} \\ {s}_{4}^{*} & - {s}_{3}^{*}\end{matrix} ] = [ \begin{matrix}{s}_{1} + γ {s}_{3} & {s}_{2} + γ {s}_{4} \\ - {s}_{2}^{*} + γ {s}_{4}^{*} & {s}_{1}^{*} - γ {s}_{3}^{*}\end{matrix} ] \qquad [ Eqn . 5 ]$$

In Equation 5, sᵢ denotes the i^{th} TX symbol, αᵢ denotes a real value of the i^{th} TX symbol, βᵢ denotes an imaginary value of the i^{th} TX symbol,

$$[ \begin{matrix}1 & 0 \\ 0 & 1\end{matrix} ] , [ \begin{matrix}0 & 1 \\ - 1 & 0\end{matrix} ] , γ [ \begin{matrix}1 & 0 \\ 0 & 1\end{matrix} ]$$

and

$$γ [ \begin{matrix}0 & 1 \\ - 1 & 0\end{matrix} ]$$

are real basises, and

$$[ \begin{matrix}1 & 0 \\ 0 & - 1\end{matrix} ] , [ \begin{matrix}0 & 1 \\ 1 & 0\end{matrix} ] , γ [ \begin{matrix}1 & 0 \\ 0 & - 1\end{matrix} ] ,$$

and

$$γ [ \begin{matrix}0 & 1 \\ 1 & 0\end{matrix} ]$$

are imaginary basises.

That is, by combining the basises as expressed in Equation 5, it is possible to generate a space-time code with a data rate of 2 that transmits 4 symbols for 2 time periods.

In the case of a 4×4 MIMO wireless communication system, an example of a code with a data rate of 1 can be expressed as Equation 6:

$${M}_{4 \times 4 , Rate 1} = [ \begin{matrix}{x}_{1} & - {x}_{2}^{*} & 0 & 0 \\ {x}_{2} & {x}_{1}^{*} & 0 & 0 \\ 0 & 0 & {x}_{3} & - {x}_{4}^{*} \\ 0 & 0 & {x}_{4} & {x}_{3}^{*}\end{matrix} ] \qquad [ Eqn . 6 ]$$

In Equation 6, M_{4×4,Rate1} denotes a space-time code with a data rate of 1 in the 4×4 MIMO wireless communication system and xₖ denotes the k^{th} TX symbol.

In the code expressed in Equation 6, the real basises are:

$$[ \begin{matrix}1 & 0 & 0 & 0 \\ 0 & 1 & 0 & 0 \\ 0 & 0 & 1 & 0 \\ 0 & 0 & 0 & 1\end{matrix} ] , [ \begin{matrix}0 & 1 & 0 & 0 \\ - 1 & 0 & 0 & 0 \\ 0 & 0 & 1 & 0 \\ 0 & 0 & 0 & 1\end{matrix} ] , [ \begin{matrix}0 & 1 & 0 & 0 \\ - 1 & 0 & 0 & 0 \\ 0 & 0 & 1 & 0 \\ 0 & 0 & 0 & 1\end{matrix} ] , and \\ [ \begin{matrix}1 & 0 & 0 & 0 \\ 0 & 1 & 0 & 0 \\ 0 & 0 & 0 & 1 \\ 0 & 0 & - 1 & 0\end{matrix} ] ,$$

and the imaginary basises are:

$$[ \begin{matrix}1 & 0 & 0 & 0 \\ 0 & - 1 & 0 & 0 \\ 0 & 0 & 1 & 0 \\ 0 & 0 & 0 & - 1\end{matrix} ] , [ \begin{matrix}0 & 1 & 0 & 0 \\ 1 & 0 & 0 & 0 \\ 0 & 0 & 0 & 1 \\ 0 & 0 & 1 & 0\end{matrix} ] , [ \begin{matrix}0 & 1 & 0 & 0 \\ 1 & 0 & 0 & 0 \\ 0 & 0 & 1 & 0 \\ 0 & 0 & 0 & - 1\end{matrix} ] and , \\ [ \begin{matrix}1 & 0 & 0 & 0 \\ 0 & - 1 & 0 & 0 \\ 0 & 0 & 0 & 1 \\ 0 & 0 & 1 & 0\end{matrix} ] .$$

By using the basises of the code expressed in Equation 6, signals can be transmitted through four (4) transmit (TX) antennas to the receiver having four (4) receive (RX) antennas. If the receiver has 2 RX antennas, the transmitter extracts some basises from the basises of the code expressed in Equation 6. If elements of positions (1,1), (1,2), (2,1), and (2,2) are extracted from the basises of the code expressed in Equation 6, the real basises are

$$[ \begin{matrix}1 & 0 \\ 0 & 1\end{matrix} ]$$

and

$$[ \begin{matrix}0 & 1 \\ - 1 & 0\end{matrix} ]$$

and the imaginary basises are

$$[ \begin{matrix}1 & 0 \\ 0 & - 1\end{matrix} ]$$

and

$$[ \begin{matrix}0 & 1 \\ 1 & 0\end{matrix} ] .$$

### The extracted basises are a set of basises that can be used in the 2×2 MIMO wireless communication system with a data rate of 1.

An example of a code with a data rate of 2 in the 4×4 MIMO wireless communication system can be expressed as Equation 7:

$${M}_{4 \times 4 , Rate 2} = [ \begin{matrix}{x}_{1} & - {x}_{2}^{*} & {x}_{5} & - {x}_{7}^{*} \\ {x}_{2} & {x}_{1}^{*} & {x}_{7} & {x}_{5}^{*} \\ {x}_{3} & - {x}_{4}^{*} & {x}_{6} & - {x}_{8}^{*} \\ {x}_{4} & {x}_{3}^{*} & {x}_{8} & {x}_{6}^{*}\end{matrix} ] \qquad [ Eqn . 7 ]$$

In Equation 7, M_{4×4,Rate2} denotes a space-time code with a data rate of 1 in the 4×4 MIMO wireless communication system and xₖ denotes the k^{th} TX symbol.

In the code expressed in Equation 7, the real basises are:

$$[ \begin{matrix}1 & 0 & 1 & 0 \\ 0 & 1 & 0 & 1 \\ 1 & 0 & 1 & 0 \\ 0 & 1 & 0 & 1\end{matrix} ] , [ \begin{matrix}0 & 1 & 1 & 0 \\ - 1 & 0 & 0 & 1 \\ 1 & 0 & 1 & 0 \\ 0 & 1 & 0 & 1\end{matrix} ] , [ \begin{matrix}1 & 0 & 0 & 1 \\ 0 & 1 & - 1 & 0 \\ 1 & 0 & 1 & 0 \\ 0 & 1 & 0 & 1\end{matrix} ] , [ \begin{matrix}1 & 0 & 1 & 0 \\ 0 & 1 & 0 & 1 \\ 0 & 1 & 1 & 0 \\ - 1 & 0 & 0 & 1\end{matrix} ] , \\ [ \begin{matrix}1 & 0 & 1 & 0 \\ 0 & 1 & 0 & 1 \\ 1 & 0 & 0 & 1 \\ 0 & 1 & - 1 & 0\end{matrix} ] , [ \begin{matrix}0 & 1 & 0 & 1 \\ - 1 & 0 & - 1 & 0 \\ 1 & 0 & 1 & 0 \\ 0 & 1 & 0 & 1\end{matrix} ] , [ \begin{matrix}0 & 1 & 0 & 1 \\ - 1 & 0 & - 1 & 0 \\ 0 & 1 & 1 & 0 \\ - 1 & 0 & 0 & 1\end{matrix} ] , and \\ [ \begin{matrix}0 & 1 & 0 & 1 \\ - 1 & 0 & - 1 & 0 \\ 0 & 1 & 0 & 1 \\ - 1 & 0 & - 1 & 0\end{matrix} ] ,$$

and the imaginary basises are:

$$[ \begin{matrix}1 & 0 & 1 & 0 \\ 0 & - 1 & 0 & - 1 \\ 1 & 0 & 1 & 0 \\ 0 & - 1 & 0 & - 1\end{matrix} ] , [ \begin{matrix}0 & 1 & 1 & 0 \\ 1 & 0 & 0 & - 1 \\ 1 & 0 & 1 & 0 \\ 0 & - 1 & 0 & - 1\end{matrix} ] , \\ [ \begin{matrix}1 & 0 & 0 & 1 \\ 0 & - 1 & 1 & 0 \\ 1 & 0 & 1 & 0 \\ 0 & - 1 & 0 & - 1\end{matrix} ] , [ \begin{matrix}1 & 0 & 1 & 0 \\ 0 & - 1 & 0 & - 1 \\ 0 & 1 & 1 & 0 \\ 1 & 0 & 0 & 1\end{matrix} ] , \\ [ \begin{matrix}1 & 0 & 1 & 0 \\ 0 & - 1 & 0 & - 1 \\ 1 & 0 & 0 & 1 \\ 0 & - 1 & 1 & 0\end{matrix} ] , [ \begin{matrix}0 & 1 & 0 & 1 \\ 1 & 0 & 1 & 0 \\ 1 & 0 & 1 & 0 \\ 0 & - 1 & 0 & - 1\end{matrix} ] , \\ [ \begin{matrix}0 & 1 & 0 & 1 \\ 1 & 0 & 1 & 0 \\ 0 & 1 & 1 & 0 \\ 1 & 0 & 0 & - 1\end{matrix} ] , and [ \begin{matrix}0 & 1 & 0 & 1 \\ 1 & 0 & 1 & 0 \\ 0 & 1 & 0 & 1 \\ 1 & 0 & 1 & 0\end{matrix} ] .$$

The transmitter extracts some basises from the basises of the code expressed in Equation 7. The extracted basises are a set of basises that can be used in the 2×2 MIMO wireless communication system.

Thus, a transmitter according to the present invention stores only a set of basises corresponding to the maximum possible number of RX antennas, generates a space-time code by extracting basises according to the number of transmitter/receiver (TX/RX) antennas, and performs space-time coding by using the generated space-time code.

In another embodiment, the transmitter according to the present invention stores only a set of basises corresponding to the minimum possible number of RX antennas, generates a space-time code by extending basises according to the number of TX/RX antennas, and performs space-time coding by using the generated space-time code.

Hereinafter, a description is given of the construction and operations of a transmitter/a receiver that performs space-time coding/decoding according to the above-description principles.

FIG. 1 is a block diagram of a transmitter for a MIMO wireless communication system according to an embodiment of the present invention.

Referring to FIG. 1, the transmitter includes an encoder 102, a modulator 104, a demultiplexer (DEMUX) 106, a space-time encoder 108, and a space-time code controller 110.

The encoder 102 encodes a transmit (TX) information bit stream to generate a coded bit stream. Examples of the encoder 102 include a convolutional encoder, a turbo encoder, and a low-density parity-check (LDPC) encoder. The modulator 104 modulates the coded bit stream from the encoder 102 to generate complex symbols. That is, the modulator 104 generates complex symbols by performing signal mapping in a constellation according to a predetermined modulation scheme. The demultiplexer 106 demultiplexes the complex signals from the modulator 104 for transmission through a plurality of transmit (TX) antennas. The space-time encoder 108 space-time encodes complex symbols received from the demultiplexer 106 using a space-time encoding code received from the space-time code controller 110, and transmits the resulting data through the antennas.

The space-time code controller 110 includes a basis generator 112, a basis selector 114, and a code generator 116. Using desired multiplexing order information, the space-time code controller 110 provides a space-time encoding code to the space-time encoder 108.

The basis generator 112 generates basises of the size corresponding to the number of TX/RX antennas from a prestored basis set. The number of RX antennas of a receiver is information that is known at the initial connection between the transmitter and the receiver. The basises can be generated by various methods according to embodiments of the present invention. For example, if a basis set corresponding to the maximum possible number of antennas is prestored, the basis generator 112 generates basises by extracting basises according to the number of TX/RX antennas. If a basis set corresponding to the minimum possible number of antennas is prestored, the basis generator 112 generates basises by extending basises according to the number of TX/RX antennas. If a basis set of a suitable size is prestored, the basis generator 112 generates basises by extending or extracting basises according to the number of TX/RX antennas.

The basis selector 114 determines the number of basises for a space-time encoding code according to a multiplexing order requested by the receiver, and selects as many basises as the determined number among the basises generated by the basis generator 112. The number of the selected basises is expressed as Equation 8:

B_{N}=(TX_{MAX,N}×2)/(SM_{MAX,N}/SM). [Eqn. 8]

In Equation 8, N denotes the number of antennas used, TX_{MAX,N} denotes the maximum number of symbols that can be transmitted over N times through N antennas, SM_{MAX,N} denotes the maximum multiplexing order in N antennas, and SM denotes a received multiplexing order.

For example, if the multiplexing order is one (1) and the number of the antennas used is two (2), four (=(4×2)/( 2/1)) basises are selected by extracting (2×2)-sized basises from the prestored basises. If the multiplexing order is four (4) and the number of the antennas used is four (4), thirty-two (=(4×4)/(½)) basises are selected by extending (2×2)-sized prestored basises.

The code generator 116 generates a space-time encoding code using the basises selected by the basis selector 114, and provides the generated space-time encoding code to the space-time encoder 108.

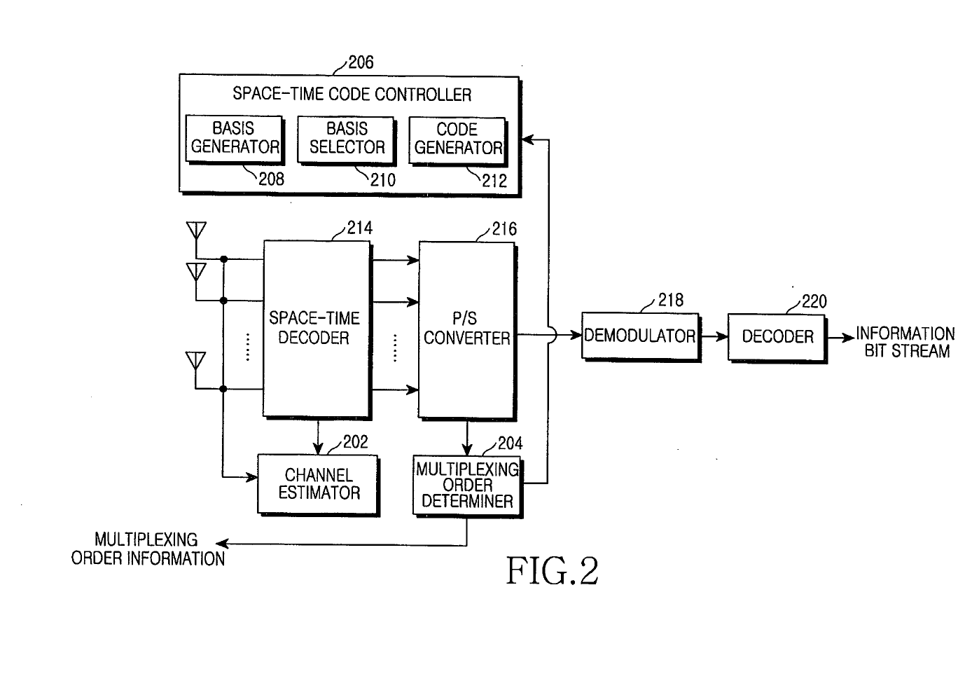

FIG. 2 is a block diagram of a receiver for a MIMO wireless communication system according to an embodiment of the present invention.

Referring to FIG. 2, the receiver includes a channel estimator 202, a multiplexing order determiner 204, a space-time code controller 206, a space-time decoder 214, a parallel-to-serial (P/S) converter 216, a demodulator 218, and a decoder 220.

The channel estimator 202 estimates a channel for each antenna for a transmitter using a predetermined signal such as a pilot signal. The multiplexing order determiner 204 determines a multiplexing order using the channel estimation value received from the channel estimator 202. For example, the multiplexing order may be calculated using the ratio of the channel estimation value to the desired data rate of the receiver. Alternatively, the multiplexing order may be calculated using the rank of a channel matrix. The rank of the channel matrix means the number of rows or columns that are linearly independent, and the channel matrix has as many non-zero eigenvalues as the rank of the channel matrix. The smallest one of the eigenvalues adversely affects the SNR-BER performance. Thus, the multiplexing order determiner 204 determines a multiplexing order after discarding a small value among the eigenvalues or setting the same to ‘0’. That is, as the remaining eigenvalues increase, the SNR-BER performance increases. In this case, the number of simultaneously-transmittable symbols, i.e., a multiplexing order decreases and thus a data rate decreases. On the other hand, as a multiplexing order increases, a data rate increases. However, if a multiplexing order is high, TX power must be increased in order to satisfy a target BER. The multiplexing order information is fed back to a transmitter.

The space-time code controller 206 includes a basis generator 208, a basis selector 210, and a code generator 212. Using the multiplexing order information received from the multiplexing order determiner 204, the space-time code controller 206 provides a space-time decoding code to the space-time decoder 214.

The basis generator 208 generates basises of the size corresponding to the number of TX/RX antennas from a prestored basis set. The number of RX antennas of the transmitter is information that is known at the initial connection between the transmitter and the receiver. The basises can be generated by various methods according to embodiments of the present invention. For example, if a basis set corresponding to the maximum possible number of antennas is prestored, the basis generator 208 generates basises by extracting basises according to the number of TX/RX antennas. If a basis set corresponding to the minimum possible number of antennas is prestored, the basis generator 208 generates basises by extending basises according to the number of TX/RX antennas. If a basis set of a suitable size is prestored, the basis generator 208 generates basises by extending or extracting basises according to the number of TX/RX antennas.

The basis selector 210 determines the number of basises for a space-time encoding code according to the multiplexing order, and selects basises as many as the determined number among the basises generated by the basis generator 208. The number of the selected basises is expressed as Equation 8 described above.

The code generator 212 generates a space-time encoding code using the basises selected by the basis selector 210, generates a space-time decoding code corresponding to the space-time encoding code, and provides the generated space-time decoding code to the space-time decoder 214.

Using the space-time decoding code received from the space-time code controller 206, the space-time decoder 214 space-time-decodes signals received through a plurality of antennas. The P/S converter 216 converts parallel signals received from the space-time decoder 214 into serial signals. The demodulator 218 demodulates the serial signals received from the P/S converter 216, thereby generating a coded bit stream. The decoder 220 decodes the coded bit stream received from the demodulator 218, thereby recovering an information bit stream.

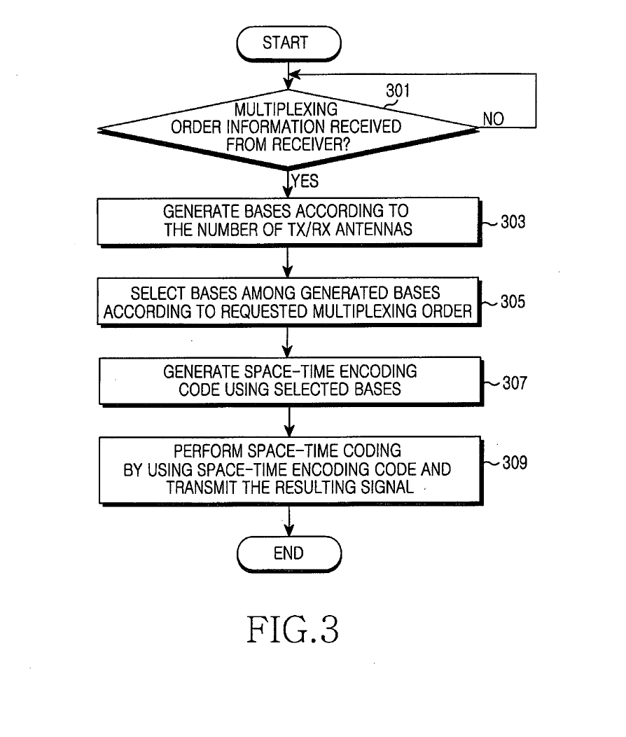

FIG. 3 is a flowchart illustrating a space-time coding procedure in a transmitter for a MIMO wireless communication system according to an embodiment of the present invention.

Referring to FIG. 3, in step 301, the transmitter determines if multiplexing order information is received from a receiver.

If the multiplexing order information is received (in step 301), the transmitter generates basises of the size corresponding to the number of TX/RX antennas from a prestored basis set, in step 303. The number of RX antennas of the receiver is information that is known at the initial connection between the transmitter and the receiver. The basises can be generated by various methods according to embodiments of the present invention. For example, if a basis set corresponding to the maximum possible number of antennas is prestored, the transmitter generates basises by extracting basises according to the number of TX/RX antennas. If a basis set corresponding to the minimum possible number of antennas is prestored, the transmitter generates basises by extending basises according to the number of TX/RX antennas. If a basis set of a suitable size is prestored, the transmitter generates basises by extending or extracting basises according to the number of TX/RX antennas.

In step 305, the transmitter determines the number of basises for a space-time encoding code according to a multiplexing order requested by the receiver, and selects basises as many as the determined number among the basises generated in step 303. For example, the number of the selected basises is expressed as Equation 8 described above.

In step 307, the transmitter generates a space-time encoding code using the selected basises.

In step 309, the transmitter space-time-encodes signals using the generated space-time encoding code, and transmits the space-time-encoded signal to the receiver.

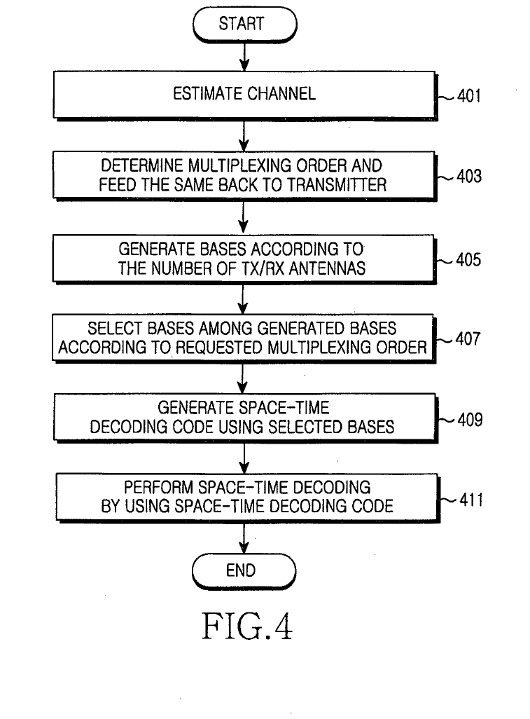

FIG. 4 is a flowchart illustrating a space-time decoding procedure in a receiver for a MIMO wireless communication system according to an embodiment of the present invention.

Referring to FIG. 4, in step 401, the receiver estimates a channel for each antenna for a transmitter using a predetermined signal such as a pilot signal.

In step 403, the receiver determines a multiplexing order using the channel estimation value in step 401. For example, the multiplexing order may be calculated using the ratio of the channel estimation value to the desired data rate of the receiver. Alternatively, the multiplexing order may be calculated using the rank of a channel matrix. The receiver feeds the multiplexing order information back to a transmitter.

In step 405, the receiver generates basises of the size corresponding to the number of TX/RX antennas from a prestored basis set. The number of RX antennas of the transmitter is information that is known at the initial connection between the transmitter and the receiver. The basises can be generated by various methods according to embodiments of the present invention. For example, if a basis set corresponding to the maximum possible number of antennas is prestored, the receiver generates basises by extracting basises according to the number of TX/RX antennas. If a basis set corresponding to the minimum possible number of antennas is prestored, the receiver generates basises by extending basises according to the number of TX/RX antennas. If a basis set of a suitable size is prestored, the receiver generates basises by extending or extracting basises according to the number of TX/RX antennas.

In step 407, the receiver determines the number of basises for a space-time encoding code according to the multiplexing order determined in step 403, and selects basises as many as the determined number among the basises generated in step 405. For example, the number of the selected basises is expressed as Equation 8 described above.

In step 409, the receiver generates a space-time encoding code using the elected basises, and generates a space-time decoding code corresponding to the space-time encoding code.

In step 411, using the space-time decoding code generated in step 409, the receiver space-time-decodes signals received through a plurality of antennas.

In the above embodiment, the receiver generates its space-time decoding code in the same method as for the transmitter. In another embodiment, the transmitter generates a space-time encoding code and provides (feedforwards) the space-time encoding code or a space-time decoding code to the receiver, and the receiver performs space-time decoding using the feedforward code information.

In the above embodiment, the transmitter selects basises for a space-time encoding code using the multiplexing order information received from the receiver. In another embodiment, the receiver transmits channel state information to the transmitter, and the transmitter determines the multiplexing order based on the channel state information received from the receiver.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. A transmitter apparatus in a multiple input-multiple output (MIMO) wireless communication system, the apparatus comprising:
a controller for generating a space-time encoding code according to a multiplexing order, the number of transmitter antennas, and the number of receiver antennas; and
a space-time encoder for space-time-encoding a transmit signal using the generated space-time-encoding code.

2. The transmitter apparatus of claim 1, wherein the multiplexing order is received from the receiver.

3. The transmitter apparatus of claim 1, wherein the multiplexing order is determined in the transmitter using a channel information received from receiver.

4. The transmitter apparatus of claim 1, the multiplexing order is calculated using the ratio of the channel estimation value to the desired data rate of the receiver in the transmitter or receiver.

5. The transmitter apparatus of claim 1, wherein the multiplexing order is the number of signals that can be received in the same time.

6. The transmitter apparatus of claim 1, wherein the controller comprises:
a basis generator for generating basises according to the number of the transmitter antennas and the number of the receiver antennas;
a basis selector for determining the number of basises according to the multiplexing order and selecting basises as many as the determined number; and
a code generator for generating the space-time encoding code using the selected basises.

7. The transmitter apparatus of claim 6, wherein the basis generator generates the basises by extending basises included in a prestored basis set according to the number of the transmitter antennas and the number of the receiver antennas.

8. The transmitter apparatus of claim 6, wherein the basis generator generates the basises by extracting basises from basises included in a prestored basis set according to the number of the transmitter antennas and the number of the receiver antennas.

9. The transmitter apparatus of claim 1, wherein the controller provides the space-time encoding code information to the receiver.

10. A receiver apparatus in a multiple input-multiple output (MIMO) wireless communication system, the apparatus comprising:
a determiner for determining a multiplexing order;
a controller for generating a space-time decoding code according to the determined multiplexing order; and
a space-time decoder for space-time-decoding a receive signal received from a transmitter using the generated space-time-decoding code.

11. The receiver apparatus of claim 10, wherein the determiner determines the multiplexing order using the channel estimation value itself.

12. The receiver apparatus of claim 10, wherein the determiner determines the multiplexing order received from the transmitter.

13. The receiver apparatus of claim 10, wherein the multiplexing order is the number of signals that can be simultaneously received by the receiver.

14. The receiver apparatus of claim 10, wherein the controller generates basises according to the number of transmitter antennas and the number of receiver antennas, selects one or more basises from the generated basises according to the multiplexing order, and generates the space-time decoding code using the selected basises.

15. The receiver apparatus of claim 10, wherein the controller generates the space-time decoding code by detecting space-time decoding code information fed back from the transmitter.

16. The receiver apparatus of claim 10, wherein the determiner determines the multiplexing order using the ratio of the channel estimation value to the desired data rate of the receiver.

17. The receiver apparatus of claim 10, wherein the determiner provides the multiplexing order information to the transmitter.

18. A method for an operation of a transmitter in a multiple input-multiple output (MIMO) wireless communication system, the method comprising:
generating basises according to the number of transmitter antennas, and the number of receiver antennas to generate a space-time encoding code;
generating a space-time encoding code according to a multiplexing order by using the generated basises; and
space-time-encoding a transmit signal using the determined space-time-encoding code.

19. The method of claim 18, wherein the multiplexing order is received from the receiver.

20. The method of claim 18, the multiplexing order is calculated using the ratio of the channel estimation value to the desired data rate of the receiver.

21. The method of claim 18, wherein the basises are generated by extending basises included in a prestored basis set according to the number of the transmitter antennas and the number of the receiver antennas.

22. The method of claim 18, wherein the basises are generated by extracting basises from basises included in a prestored basis set according to the number of the transmitter antennas and the number of the receiver antennas.

23. A method for an operation of a receiver in a multiple input-multiple output (MIMO) wireless communication system, the method comprising:
determining a multiplexing order;
generating a space-time decoding code according to the determined multiplexing order; and
space-time-decoding a receive signal received from a transmitter using the generated space-time-decoding code.

24. The method of claim 23, wherein the multiplexing order is determined by using the channel estimation value.

25. The method of claim 23, the multiplexing order is received from the transmitter.
